(19) United States
(12) Patent Application Publication
(10) Pub. No.: US 2016/0078420 A1
(43) Pub. Date: Mar. 17, 2016

(54) METHOD FOR FINANCING PURCHASES FOR OTHERS USING A SENDER'S CHARGE ACCOUNT

(71) Applicant: GlobalPay Solutions USA, Inc., Miami, FL (US)

(72) Inventor: Federico J. BARILLAS, Miami Beach, FL (US)

(73) Assignee: GlobalPay Solutions USA, Inc., Miami, FL (US)

(21) Appl. No.: 14/929,747

(22) Filed: Nov. 2, 2015

Related U.S. Application Data
(62) Division of application No. 14/280,627, filed on May 18, 2014.
(60) Provisional application No. 61/970,903, filed on Mar. 27, 2014.

(51) Int. Cl. G06Q 20/16; H04M 17/00; H04M 15/00; G06Q 20/32; G06Q 30/06

(52) U.S. Cl. CPC G06Q 20/16; G06Q 20/3255; G06Q 30/0633; H04M 15/68; H04M 17/204

(57) ABSTRACT

A method allows a sender to buy goods or services for a third party immediately on an established account of the sender even before the sender pays for the expense occurred. The system works particularly well for purchases of mobile telephone airtime for others. In addition, the method works equally well for purchases of small amounts. The method utilizes SIMS protocol to send purchase orders in the form of text messages. The method takes advantage of existing technologies and contractual relationships that SIMS aggregators have with carriers. The method allows brokers to buy large quantities of goods and services such as mobile telephone airtime at discounted wholesale prices and then resell them in smaller quantities at higher retail prices.

### BACKGROUND OF THE INVENTION

1. Field of the Invention

The invention relates to electronic payments by one party for another, particularly a sender purchasing mobile telephone airtime for a recipient.

2. Other Related Applications

The present application is a divisional of pending U.S. patent application Ser. No. 14/280,627, filed on May 18, 2014 by its sole Inventor Federico J. BARILLAS, which in turn claims the benefit of U.S. Provisional Application No. 61/970,903, filed Mar. 27, 2014, both are hereby incorporated by reference. The present application is therefore filed to continue protection after the Restriction/Election Requirement of the U.S. patent application Ser. No. 14/280,627. Applicant claims the benefit of prior nonprovisional application under 35 U.S.C. 121 or 365(c) to protect what the Examiner considered Species VI. “A method for a first carrier to sell mobile telephone airtime on the first carrier to a purchaser using a second carrier”, (claims 19-21, classified in G060 2220/12, G060 2220/123, H04M 15/61.

3. Description of the Related Art

In the United States, a majority of mobile telephone users has a contract requiring a monthly payment in exchange for a bundle of services: i.e. a quantity of call minutes, a quantity of SMS messages, and an amount of data. When the user exceeds the contract's limits, the mobile phone owner's account is billed on the next month's bill.

In contrast, in other countries, a majority of mobile telephone users use prepaid plans, as opposed to contracts. In prepaid plans, the user purchases an amount of airtime, SMS messages, or data before the user consumes them. Once the pre-paid supply is exhausted, the user purchases additional services to replenish his or her account.

Another difference in consumption of mobile telephone services outside the United States, is that owners frequently purchase airtime in micropayments. For example, users frequently pay one dollar each day ($1/day) to provide for that day's airtime. To avoid missing calls, the replenishment system for mobile telephones needs to work in real time.

Many immigrants and their family members work in the United States and send money to their families still living in their countries of origin. Many family members working in the United States prefer to direct payments for particular services, rather than making lump payments that are distributed at the recipient's discretion. By directing payment, the risk of allocating against the sender's intent is minimized. However, the cost of transferring money by traditional services prevents senders from sending multiple payments of smaller amounts for goods and services directly to approved vendors. In addition, many senders and recipients do not use the banking system but still need to send payments electronically.

Accordingly, a need exists to provide a method for sending money in small amounts directly to approved vendors.

Within the field of mobile communications, SMS aggregators exist. SMS aggregators have contracts with mobile carriers to provide services to mobile phone owners. In exchange for providing the services, the SMS aggregator bills the mobile carrier of the purchaser. In turn, the mobile carrier bills the user (i.e. the purchaser/recipient of the service). When the user pays his or her bill, the carrier retains part of the fee and disburses the remainder to the SMS aggregator. Typical goods services offered by SMS aggregators include ringtones, games, themes, wallpapers, and digital music files.

To facilitate purchases, SMS aggregators use SMS messaging to initiate purchases, to deliver content, and to track billing.

SMS aggregators have completed the significant effort of creating relationships with various mobile phone carriers and of qualifying themselves as vendors.

In light of regulatory changes that limited SMS aggregators from selling their traditional services, many SMS aggregators are seeking new sources of income that can utilize their existing relationships with mobile phone carriers.

An object of the invention is to provide a method for financing purchases for others using a sender's charge account that overcomes the disadvantages of the devices and methods of this general type and of the prior art.

To meet the objects, the invention includes a method for financing a purchase for a recipient on an account of a sender. The recipient does not need to have a relationship with the creditor of the sender's account. Instead a broker of the creditor and a broker of the recipient acts as intermediaries. The broker of the recipient can rely on the obligations between the sender and the creditor to deliver goods or servers before receiving payment from the sender. For example, the invention provides a method for allowing a mobile telephone user to purchase mobile telephone airtime for a recipient and have the purchase price billed to the user's account, even if the recipient uses a different carrier than the sender.

In a first step of the invention, a sender establishes an account with a creditor. An account is a record of debit and credit entries to cover transactions between the sender and the creditor. The sender is obliged to repay the creditor for transactions debited to the account. A contract between the sender and the creditor can obligate the sender to repay debits on the sender's account. A sender is a party that can form an obligation with the creditor. A sender can be a person or legal entity such as a corporation. With regard to the invention, a sender is a party that intends to purchase a good or service, such as mobile telephone airtime, for a recipient.

Using the mobile telephone airtime example, a mobile telephone service carrier is a creditor to a sender. The sender has a contract to pay an agreed upon amount of money for a quantity and quality of mobile telephone airtime. In addition, the sender is obligated by the contract to pay the carrier for additional services that the sender buys from the carrier. The carrier typically bills the sender monthly for the sender's monthly fee plus any additional purchases. The bill usually specifies a thirty-day period for the sender to pay the sender's account.

After the sender establishes the account, the sender sends a purchase order to a broker of the creditor. The purchase order should identify the account of the sender, the recipient, and the good or service to be purchased. Using the example of a sender buying a recipient mobile telephone airtime, the purchase order could include a telephone number of the sender to identify the sender's account, a price of mobile telephone airtime to be purchased for the recipient, and the mobile telephone number of the recipient. The broker can use a computer to parse a sender's telephone number from the message to remove the requirement that the sender add the sender's telephone number.

A broker is an agent who negotiates contracts of purchase and sale for someone else. According to the invention, the creditor has a broker (i.e. a creditor broker) that is authorized to negotiating contracts with users of the creditor, for example, the sender. The creditor's broker is further authorized to make contracts to purchase goods and services for the creditor.

According to the invention, the creditor broker is authorized to make purchasers for account holders of the creditor. The creditor has contracted with the creditor broker to bill the creditor's account holders on behalf of the broker for the goods and services bought by the account users through the creditor broker.

Returning to the method according to the invention, after the sender submits the purchase order, the next step is debiting the account of the sender for the price of the good or service. The price to be debited is the retail price of the good and service.

After the creditor broker receives the purchase order from the sender, the creditor broker sends a purchase order for the good or service from the broker of the creditor (A/K/A the creditor broker) to a broker of a supplier (A/K/A a supplier broker). The purchase order should identify the recipient and the good or service to be delivered.

According to the invention, the supplier broker is authorized to negotiate sales contracts for other parties and the creditor. For example, the supplier broker can buy goods and services from the supplier and instruct the supplier to deliver the goods and services to an end user, for example, the recipient. The creditor's broker is further authorized to make contracts to purchase goods and services for the creditor.

After the supplier broker receives the purchase order, the supplier broker sends a purchase order from the supplier broker to the supplier. The purchase order should specify the recipient and the good or service to be delivered by the supplier.

The supplier delivers the good or service from the supplier to the recipient based on the purchase order.

According to the invention, after the sender credits (i.e. pays) the sender's account, the creditor reimburses the broker of the supplier. The reimbursement can pass through intervening brokers or directly to the supplier broker.

In accordance with a further object of the invention, the method is particularly useful in the mobile telephone example. In this example, the creditor is a mobile telephone service carrier. A carrier is also known as a service provider. The sender is a mobile telephone user with a mobile telephone associated with the account with the mobile telephone service carrier. The purchase order from the sender to a broker of the creditor is sent from the mobile telephone of the sender. Sending a purchase order from a mobile telephone of the sender helps to authenticate the sender with the account.

The purchase order from the sender to a broker of the creditor can be a text message sent by SMS protocol from the mobile telephone of the sender. The text message should include a telephone number of the recipient and a price that the sender is to be charged. Text messages sent by SMS protocol are particularly useful because SMS protocol is a ubiquitous standard. In addition, a computer can parse easily text messages. In addition, the text characters are a limited set that can be easily parsed by a computer at the creditor broker to read the recipient's country code, telephone number, and price of time to be purchased. An SMS text message also identifies the mobile telephone number of the sender, which can be easily related to a carrier and account number.

Continuing the mobile telephone example, the method according to the invention can be used by a sender to purchase mobile telephone airtime credit for a recipient. Mobile telephone airtime credit means a value that can be used by the recipient to purchase mobile telephone call time, SMS messages, internet data, and other goods and services sold by a mobile phone carrier.

The method of the invention is particularly useful for sending small amounts of mobile telephone airtime. Many mobile telephone users replenish their pay-as-you-go mobile phones with small purchases. An analysis showed that mobile phone users replenish their pay-as-you-go mobile telephones on a daily business and that the size of the purchase is only enough to cover the particular day. The invention allows for a sender to purchase mobile telephone minutes in small, daily-sized purchases because the method does not charge a large (i.e. greater than $5) transaction fee. A small amount of mobile telephone airtime presently can be purchased for no more than five United States Dollars (>$5 USD). Typically, purchases will be made for one United States Dollar ($1 USD).

An additional benefit of limiting transfers to small sized transaction amounts is that the method becomes inconvenient to launder money. By capping transaction sizes to no more than five dollars $5), too many transactions would be required to transfer a significant aggregated amount to an account of a user in a foreign country. In addition, by purchasing a good or service, the transaction has a quid-pro-quo that inhibits laundering.

In accordance with a further object of the invention, the creditor broker can be an SMS aggregator. An SMS aggregator provides connectivity with mobile telephone carriers by offering an effective gateway to both send and receive messages and other multimedia or digital content. SMS aggregators have contracted with at least one mobile telephone carrier to allow the aggregator to sell goods and services to the carrier's users. The price of the goods and services are billed to the User's account with the carrier. The SMS aggregator is paid when the user pays the user's account.

SMS aggregators provide a number for users to submit orders via text message using the SMS protocol. The number is preferably an SMS short code. The number can be a mobile telephone number or other identifier. Short codes are designed to be easier to read and remember than normal telephone numbers. The short code is maintained by the creditor broker and is affiliated with the seller broker. When the creditor broker receives a purchase order, i.e. a request to transfer mobile airtime, at a particular number, the SMS aggregator knows to which seller broker to pass the purchase order.

To lower the cost of buying goods and services from the supplier, the supplier broker can aggregate goods and services being bought by multiple senders to send to various recipients. By aggregating the goods and services, the supplier broker increases its purchasing power and can negotiate a lower wholesale price. In the mobile telephone airtime market, the supplier broker can buy a pool of mobile telephone airtime in advance at a discount. Then as purchase orders arrive, the seller broker can contact the supplier to allocate immediately a portion of the pre-purchased mobile airtime pool to a specified recipient. The supplier broker can charge the sender a retail price for the goods and services purchased. The difference between the wholesale and retail prices add to the supplier broker's profits.

A further object of the invention is to provide a method for delivering a good or service in near real time to a recipient from when the sender ordered it. An additional related object is to relay a confirmation of a delivery of the good or service from the supplier to the purchaser as quickly as possible. The contractual chain of relationships (i.e. purchaser-creditor, creditor-creditor broker, creditor broker-supplier broker, supplier broker-supplier, and supplier-recipient) enable the supplier to deliver the ordered good and service immediately after the supplier receives the purchase order from the broker of the purchaser. Immediate means that none of the parties in the chain need to receive actual payment before the good or service is delivered. No upfront payment is required because the parties trust their contractual obligations and the level of risk of breach of contract is not excessive.

The invention includes a method for reimbursing a broker of a first mobile telephone carrier for purchases of mobile telephone airtime on another mobile telephone carrier. In this method, a sender establishes an account with a creditor. The creditor and the creditor broker form a contractual obligation. The creditor broker and a supplier broker form a contractual relationship. The creditor broker receives a purchase order from the sender and passes the purchase order to the supplier broker.

The creditor broker then receives an invoice for the good or service from the supplier broker. The invoice identifies the account of the purchaser and a price to the purchaser.

The creditor broker forwards the invoice to the creditor. The creditor broker receives a payment from the creditor when the sender pays the account. The creditor broker retains a portion of the payment and forwards the remainder to the supplier broker. The size of the portion kept by the creditor broker is established by the contract between the creditor broker and the supplier broker.

The invention includes a method for brokering a purchase of wireless telephone airtime for a recipient that uses a different carrier than a purchaser. The method includes receiving a purchase order from a mobile telephone user, i.e. the sender or purchaser. The purchase order includes a price to the purchaser. The broker of the sender's carrier sends an invoice to a carrier of the purchaser for the price. The sender's carrier's broker sends a purchase order for the wireless airtime to a broker of a carrier of the recipient. The sender's carrier's broker is paid a portion of the price of the wireless airtime upon payment by the sender to the carrier of the sender. The remainder of the payment can be forwarded to the broker of the supplier.

The invention includes a method for selling mobile airtime of a first carrier to a purchaser using a second carrier. The method includes purchasing mobile telephone airtime on the first carrier, i.e. the supplier. The next step involves allocating the mobile telephone airtime to a mobile telephone account of a recipient after receiving a purchase order. The purchase order should identify an account of the purchaser with the second carrier, i.e. the creditor. The purchase order should include a price of mobile telephone airtime to be bought. After allocating the airtime to the recipient, the next step is sending an invoice to the second carrier. The invoice should identify the account of the purchaser and a price for the mobile telephone airtime. A pool of mobile telephone airtime can be purchased in advance to take advantage of discounted bulk pricing. An alternative would be to purchase more mobile telephone airtime from the first carrier than the sender requests after receiving the purchase order. The extra mobile telephone airtime can be sold to a subsequent recipient in a subsequent purchase.

The invention includes a method for a first carrier to sell mobile telephone airtime on the first carrier to a purchaser using a second carrier. The method includes receiving a purchase order. The purchase order should identify a mobile telephone account of a recipient on the first carrier and a value of mobile telephone minutes. The next step involves allocating the value of mobile telephone minutes on the first carrier to the mobile telephone account of the recipient. The next step involves sending an invoice to the second carrier. The invoice should identify a mobile telephone account of the sender and a price of the mobile telephone minutes. The purchase order can be derived from a text message sent by SMS protocol from the mobile device of the sender. The first carrier can allocate the amount of mobile telephone minutes before the sender pays the invoice.

The invention includes a method of selecting when to buy mobile telephone airtime from a supplier carrier. When the difference of the price charged by the purchaser's carrier minus the cost charged by the seller's carrier is greater than a transaction cost charged by the purchaser's carrier plus a transaction cost charged by the purchaser's carrier's broker's transaction cost, plus other transaction costs, then a supplier's broker should purchase mobile telephone airtime from the supplier. Likewise, if the condition is not met, the supplier's broker should not purchase mobile telephone airtime from the supplier carrier.

The invention includes a method for determining what price to buy mobile telephone airtime from the supplier carrier. The supplier's broker should offer to buy mobile telephone airtime from the supplier at a price that is less than the price charged to a purchaser less the sum of a transaction cost charged by the purchaser's carrier and the purchaser's broker and other costs.

Other features that are considered as characteristic for the invention are set forth in the appended claims.

Although the invention is illustrated and described herein as embodied in a method for financing purchases for others using a sender's charge account, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a screenshot of a mobile phone screen showing a user initiating a purchase.

FIG. 2 is a screenshot of a mobile phone screen showing a request for confirmation of the purchase.

FIG. 3 is a screenshot of a mobile phone screen showing the sender confirming the purchase.

FIG. 4 is a screenshot of a mobile phone screen showing confirmation of the purchase.

FIG. 5 is a schematic drawing showing a billing cycle in a method according to the invention.

FIG. 6 is a schematic drawing showing an international purchase process.

FIG. 7 is a schematic drawing of a system according to the invention.

### DETAILED DESCRIPTION OF THE INVENTION

A preferred embodiment of the invention is a method for purchasing mobile phone airtime for another by advancing the cost of the purchased time until the sender's carrier reimburses the cost after the sender pays the sender's telephone bill.

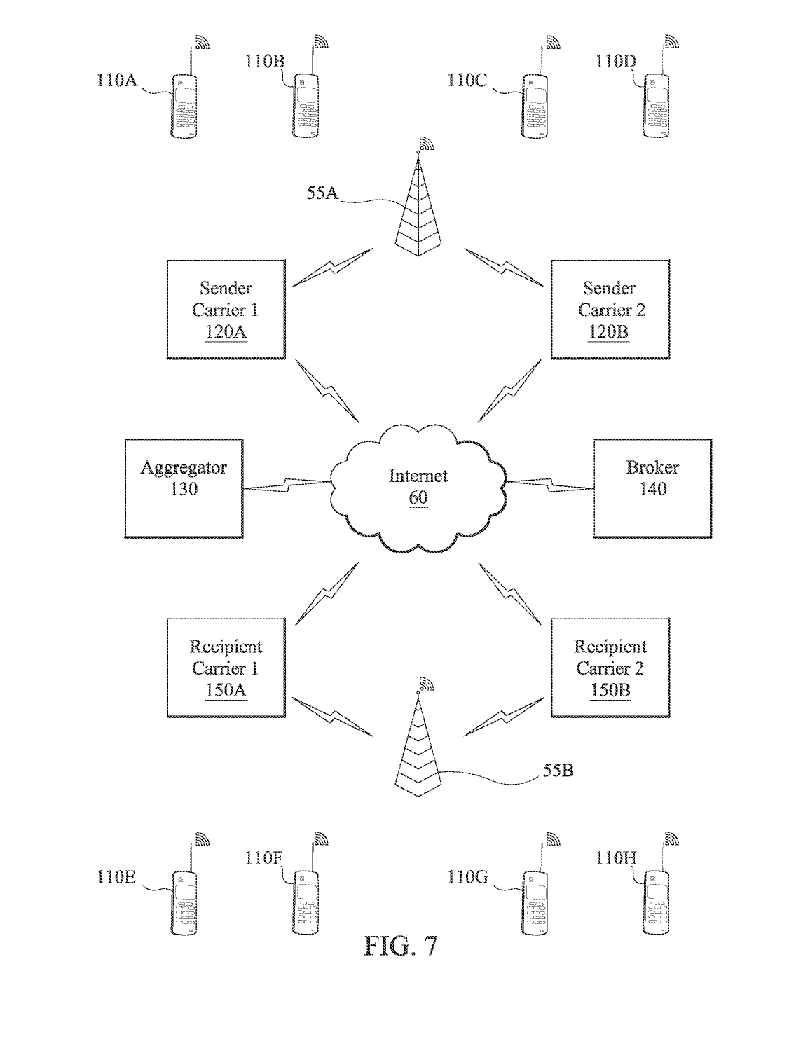

FIG. 7 shows an embodiment of a system that can be utilized with the method according to the invention. A plurality of senders 110A, 110B, 110C, and 110D use a client to access a network 55A. Senders are also referred in this application as purchasers and mobile users. Preferred embodiments of clients include mobile telephones, smartphones, and wireless network adapters. A preferred embodiment of the network 55A is a mobile telephone and data network. Senders have a contract with a carrier to provide access to the network 55A. In the example shown in FIG. 7, sender 110A and sender 110B have contracts with sender carrier 120A to provide senders 110A and 110B access to the network 55A. Sender 110C and 110D have contracts with sender carrier 120B to provide the senders 110C and 110D access to the network 55A. Each sender carrier 120A and 120B is connected via a network. Preferably, the network is the Internet 60.

An aggregator 130 is connected to the mobile network 55A and the sender carriers 120A and 120B via the Internet 60. The aggregator 130 hosts a computer server connected to the mobile network 55A. The server receives, parses, processes, and logs purchase orders received from senders 110A, 110B, 110C, and 110D. The aggregator 130 is a broker of the sender carriers 120A and 120B. The aggregator 130 has contracted with each of the sender carriers 120A and 120B to receive purchase orders from senders of carrier 120A and 120B and to invoice the sender carriers 120A and 120B for purchases made by the given sender carriers' 120A or 120B senders.

A recipient broker 140 is an agent authorized to buy and resell mobile telephone airtime from recipient carriers. The recipient broker 140 hosts a computer server connected to the Internet 60. The computer server receives purchase orders forwarded by the Aggregator 130, processes the purchase orders, and logs the purchase orders. The computer server sends instructions to the recipient carriers 150A or 150B to allocate purchased mobile telephone airtime to respective recipients 110E, 110F, 110G, or 110H based on the purchase orders. The computer server sends invoices for the purchased mobile telephone airtime from the broker 140 to the aggregator 130. Preferably, the recipient broker 140 is authorized to make purchases from many recipient carriers, for example recipient carrier 150A and recipient carrier 150B. The broker 140 has a contract with each recipient carrier 150A and 150B to purchase mobile airtime and then allocate this airtime to various recipients 110E, 110F, 110G, and 110H, who are clients on the recipient carriers 150A or 150B. The broker 140 has a contract with the aggregator 130 as well. The contract between the broker 140 and the aggregator 130 obligates the aggregator 130 to forward to broker 140 purchase orders to be filled by the broker 140. The aggregator 130 is obligated to invoice sender carriers 120A and 120B for the price of purchase orders forwarded to the broker 140. The contract provides for the aggregator 130 to retain a portion of the payment when reimbursed by the sender carriers 120A and 120B.

The broker 140 owns a mobile telephone number for receiving purchase orders from the senders 110A, 110B, 110C, and 110D. Preferably, the purchase orders are text messages sent by SMS protocol to the mobile telephone number of the broker 140. The aggregator 130 hosts the mobile telephone number of the broker 140. Preferably, the mobile telephone number of the broker 140 is an SMS short code.

The recipients 110E, 110F, 110G, and 110H are mobile device users on the mobile network 55B. In the example shown, the recipients 110E and 110F are prepaid account users on recipient carrier 150A. The recipient carrier 150A provides the recipients 110E and 110F access to mobile telephone network 55B. The recipients 110G and 110H are account holders with recipient carrier 150B. The recipient carrier 150B provides recipients 110G and 110H access to mobile telephone network 55B.

The mobile telephone networks 55A and 55B can be located in the same or different countries.

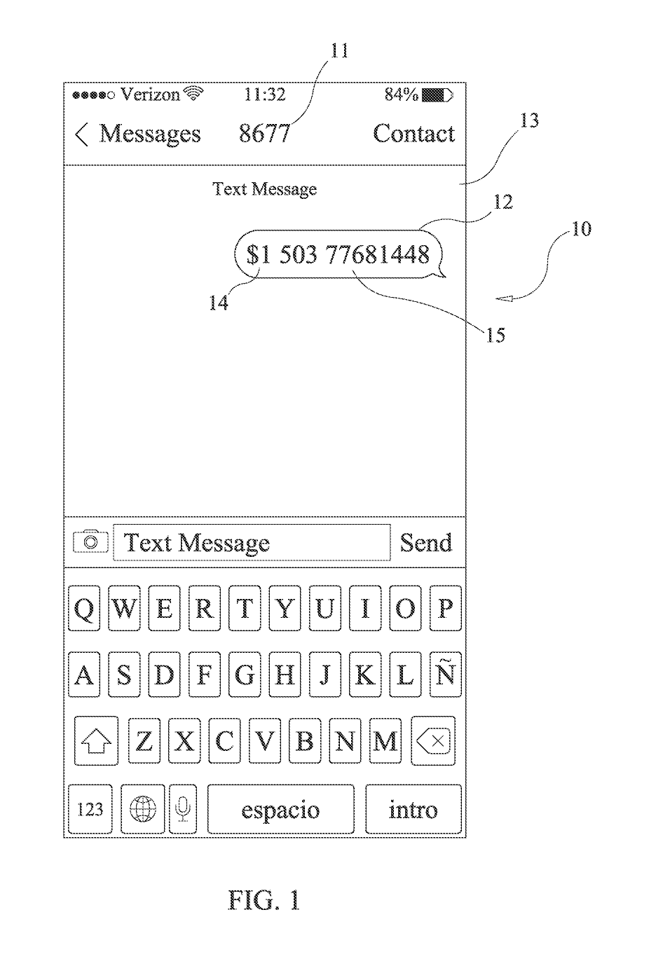

FIGS. 1-4 show the process by which a sender 110 uses a mobile phone to initiate a purchase of airtime for a recipient. FIGS. 1-4 are screenshots of a window 10 displayed by an SMS application running on a mobile phone. Within the window 10 a message transcript window 13 shows a conversation view of the transaction.

In a preferred embodiment, a sender begins an engagement by sending a purchase order in the form of a text message 12 to a mobile telephone number 11. The mobile telephone number 11 is associated with a broker 140. The mobile telephone number 11 is hosted by the aggregator 130. The purchase order includes a price 14 to be paid by the sender and a recipient address 15 in the form of a mobile telephone number of the recipient. The recipient's mobile telephone number 15 includes a country area code for international recipients. Preferably, the mobile telephone number 11 is a short code. FIGS. 1-4 use the short code “8677” as the mobile telephone number 11 associated with the broker 140.

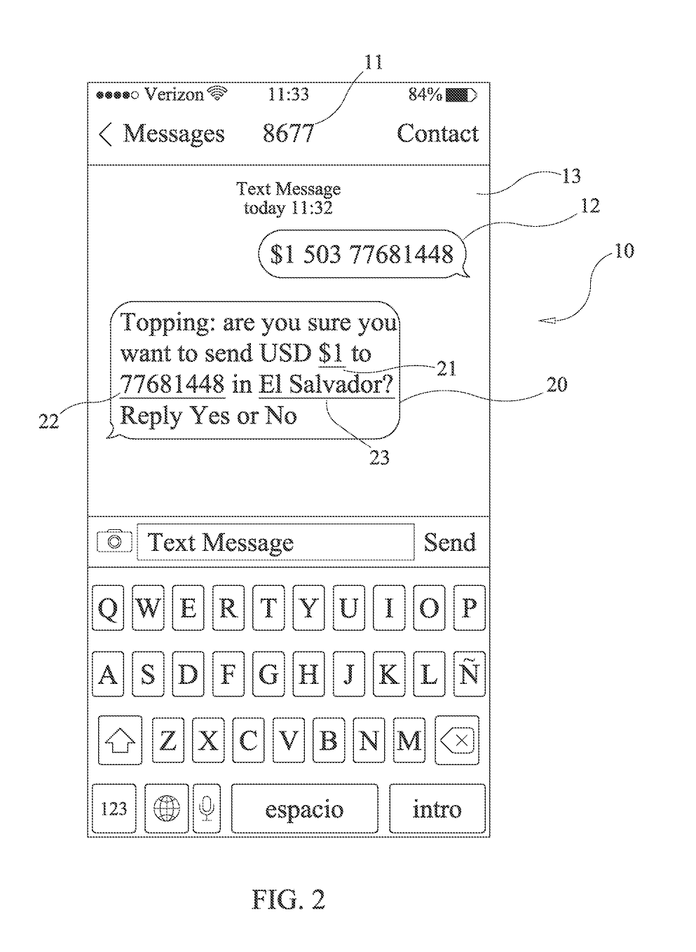

The SMS aggregator 130 receives the text message 12 from the sender 110. The SMS aggregator 130 parses the text message 12 to identify the recipient's country, the price 14, the sender's mobile telephone number, and the sender's mobile telephone carrier 120. As shown in FIG. 2, the SMS aggregator 130 returns a text message 20 to the sender 110. The text message 20 includes the price 21 to be charged, the recipient's telephone number 22, the recipient's country 23, and includes a request for the sender to confirm the transaction by replying “yes” or “no”.

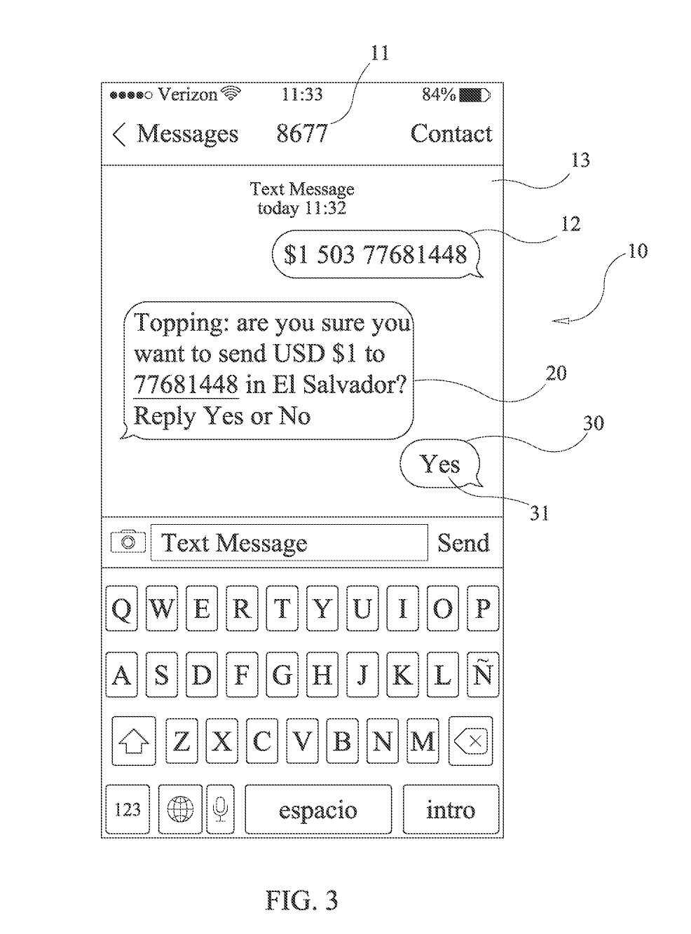

FIG. 3 shows a text message 30 in which the sender 110 confirmed the transaction listed in text message 20 by sending a confirmation 31 to the mobile telephone number 11 of the broker 140.

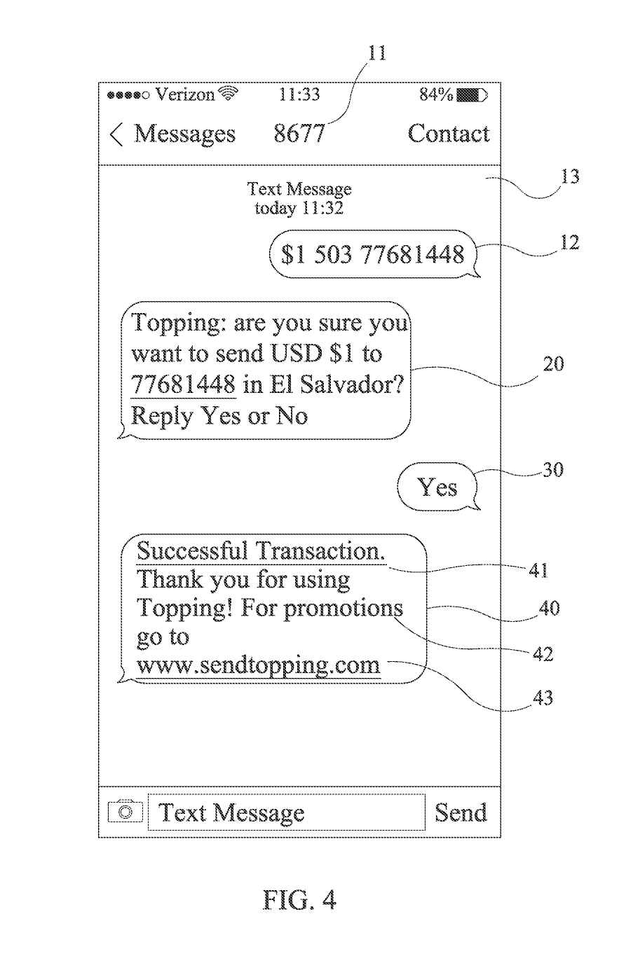

The aggregator 130 reports the purchase order to the broker 140 in real time. The broker 140 credits an amount of airtime on the recipient's carrier 150 whose value is no greater than the price 14 minus a cost charged by the aggregator 130 and a cost charged by the sender's carrier 150. The amount of airtime to the recipient can be based on a retail rate even if the broker 140 is purchasing the airtime at a wholesale price. The recipient's carrier 150A sends the recipient 110E a text message confirming the amount of airtime purchased for the recipient 110E. FIG. 4 shows a text message 40 from the aggregator 130 to the sender 110A. The text message 40 includes a confirmation 41. The text message 40 further includes a promotional message 42 and a hyperlink 43 to a website of the broker 140.

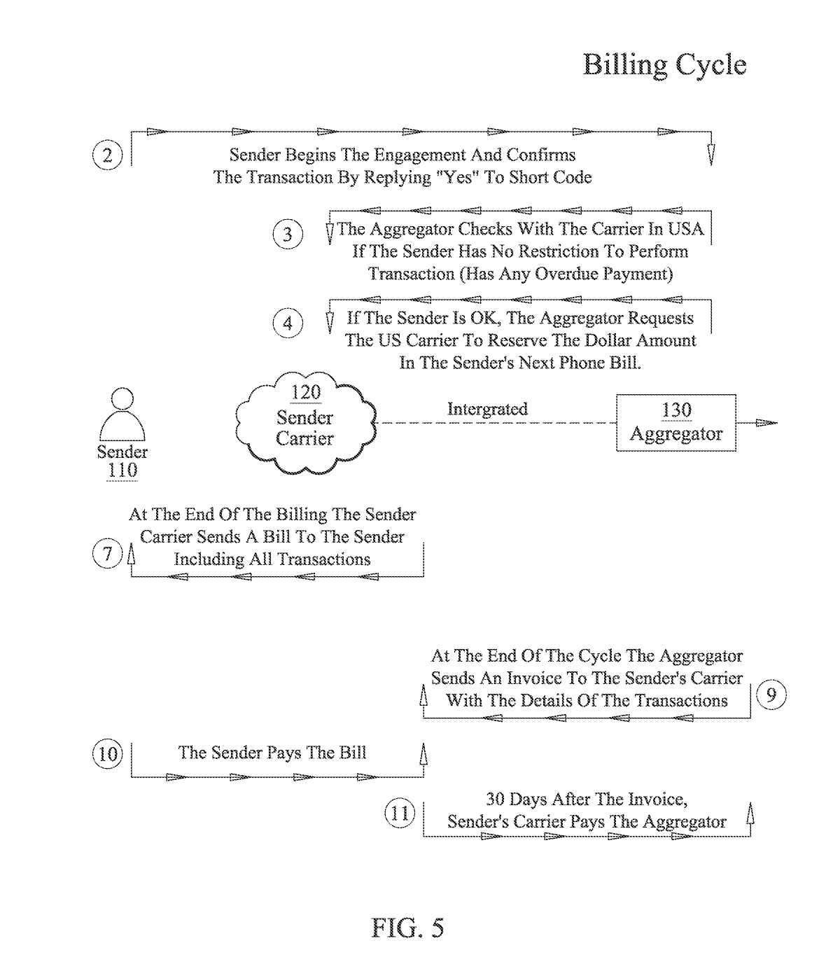

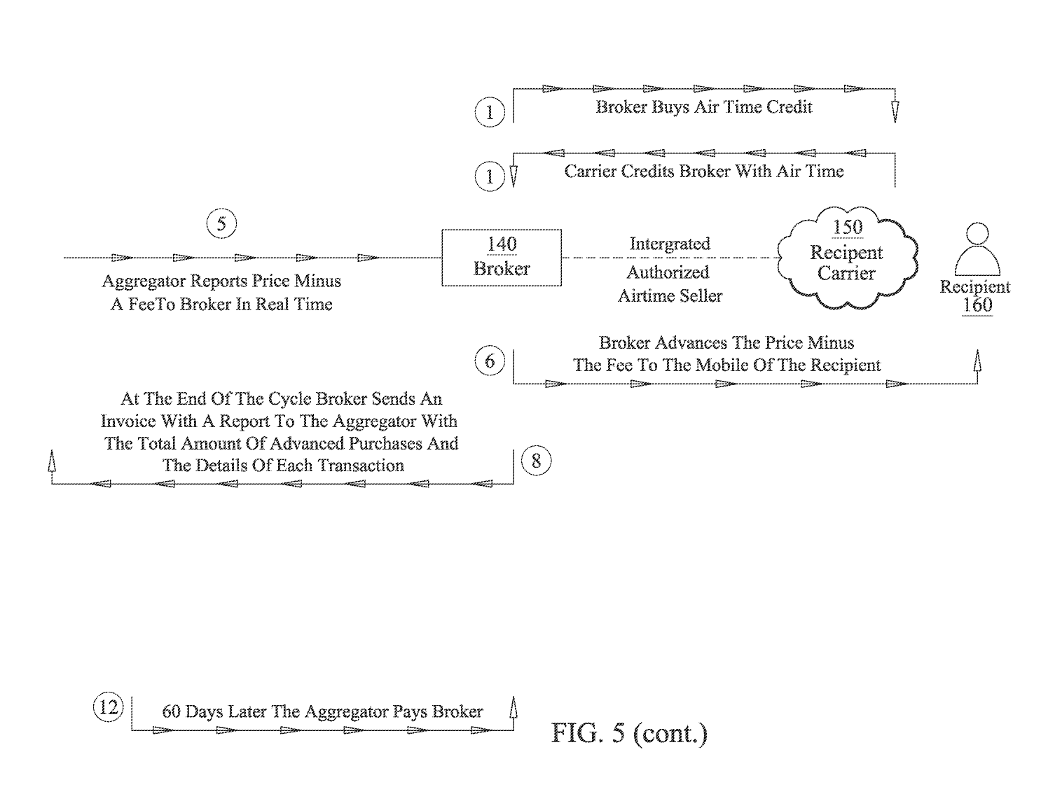

FIG. 5 shows a preferred embodiment of a billing cycle. In step 1A, the broker 140 buys mobile telephone airtime from a recipient carrier 150A. Preferably, the broker purchases large amounts of airtime at a discounted wholesale rate and then sells the airtime at a higher retail rate. Large amounts of mobile telephone airtime means more mobile telephone airtime than is to be purchased in one particular purchase by a sender. In step 1B, the recipient carrier 150A credits the broker 130 with the mobile telephone airtime. In step 2, a sender 110A begins the engagement and confirms the transaction by replying “Yes” to the short code 11 associated with the broker 140. In step 3, the aggregator 130 checks with the sender's carrier 120A for payment and credit issues. If the sender's carrier 120A identifies no issues with an account of the sender 110A, the sender's carrier 120A will notify the aggregator 130 to continue. In step 4, the aggregator 130 requests the sender's carrier 120A to reserve the price 14 in the sender's request 12 on the next telephone bill of the sender 110A. In step 5, the aggregator 130 reports to the broker 140 the recipient address 15 and the price 14 minus a fee for the aggregator 130 and minus a fee for the sender's carrier 110A. In step 6, the broker 140 allocates an amount of mobile telephone airtime to the recipient 110E that can be purchased at retail by the price 14 minus the costs charged by the sender's broker 120A and the aggregator 130. Steps 2-6 are to occur in near real time. The term “near real time”, refers to the time delay introduced, by automated data processing or network transmission, between the occurrence of an event and the use of the processed data, such as for display or feedback and control purposes. For purposes of this application, the term “real time” is meant to be synonymous with “near real time”.

The remaining steps in the method typically occur according to the contractual terms that the parties set when establishing their billing cycles. In step 7, the sender's carrier 120A sends a bill to the sender 110A. The bill includes the price 14 for each purchase order sent to the aggregator 130 in the billing period. In step 8, the broker 140 sends an invoice to the aggregator 130. The invoice includes a total retail value of mobile telephone airtime advanced by the broker 140 and a detail of each transaction including a recipient address 15 and a transaction retail value. In step 9, the aggregator 130 sends an invoice to the sender's carrier 120A. The invoice includes a total of purchase orders sent by senders 110A and 110B of the carrier 120 to the aggregator 130 as well as the details of the transactions including the sender's mobile telephone number and price 14. In step 10, the sender 110A pays the bill of the sender's carrier 120A. In step 11, thirty (30) days after the invoice from the aggregator 130 is dated, the sender's carrier 120A pays the aggregator 130. The payment includes the retail price of the value of the airtime sold by the broker 140 plus the cost charged by the aggregator 130. In step 12, sixty (60) days after the sender's carrier 120A pays the aggregator 130, the aggregator 130 pays the broker the retail price of the mobile telephone airtime sold by the broker 140. The aggregator 130 retains a cost charged as arranged by contract.

Calculations can be made based on the billing cycle shown in FIG. 5. In step 1A, the broker 140 buys mobile telephone airtime n_{RC} at a wholesale price Pw. The revenue of the recipient carrier R_{RC} and the cost for the broker CB can be calculated.

P_{w}−n_{rc}=R_{rc}=C_{B}

In step 2, a sender 110A begins the engagement by send purchase order including a price to the sender Ps. In step 5, the aggregator 130 reports the purchase price Ps less a cost Csc charged by the sender's carrier and less a cost CA charged by the aggregator. From this, the revenue of the broker R_{B} can be calculated.

Ps−Csc−C_{A}=R_{B}

In step 6, the broker charges a cost for the transaction C_{B}. Then, the broker advances the net amount of mobile telephone airtime T R to the mobile number of the recipient. In a preferred embodiment, the retail price PR for buying mobile telephone airtime from the recipient's carrier is used when calculating the amount.

(R_{B}−C_{B})/P_{R}=T_{R}

In step 7, the Sender's Carrier sends a bill Bs to the sender 110A including a number ns of purchases made from the aggregator 130.

Bₛ=P_{S}.n_{S}

In step 8, the broker 140 sends an invoice I_{A} to the aggregator 130. The invoice represents the broker's revenue R_{B} from that aggregator.

I_{A}=R_{B}

In step 9, the aggregator 130 sends an invoice Isc to the sender's carrier.

I_{A}=I_{SC}

In step 10, the sender 110A pays his or her phone bill Bs to the sender's carrier 120A. In step 11, thirty (30) days after the invoice, the sender's carrier 120A pays the aggregator 130 the invoiced amount T_{AB} and retains the cost Csc of the sender's carrier 120A, which equals the aggregator's revenue R_{A}.

B_{S}−C_{SC}=I_{AB}−R_{A}

In step 12, the aggregator 130 pays the broker the invoiced amount IA and retains a cost CA kept by the aggregator 130. The amount paid to the broker 140 is the broker's revenue R_{B}.

R_{A}−C_{A}=I_{A}=R_{B}

By using these variables, costs charged by parties can be negotiated. Likewise, purchasing opportunities can be evaluated for profitability.

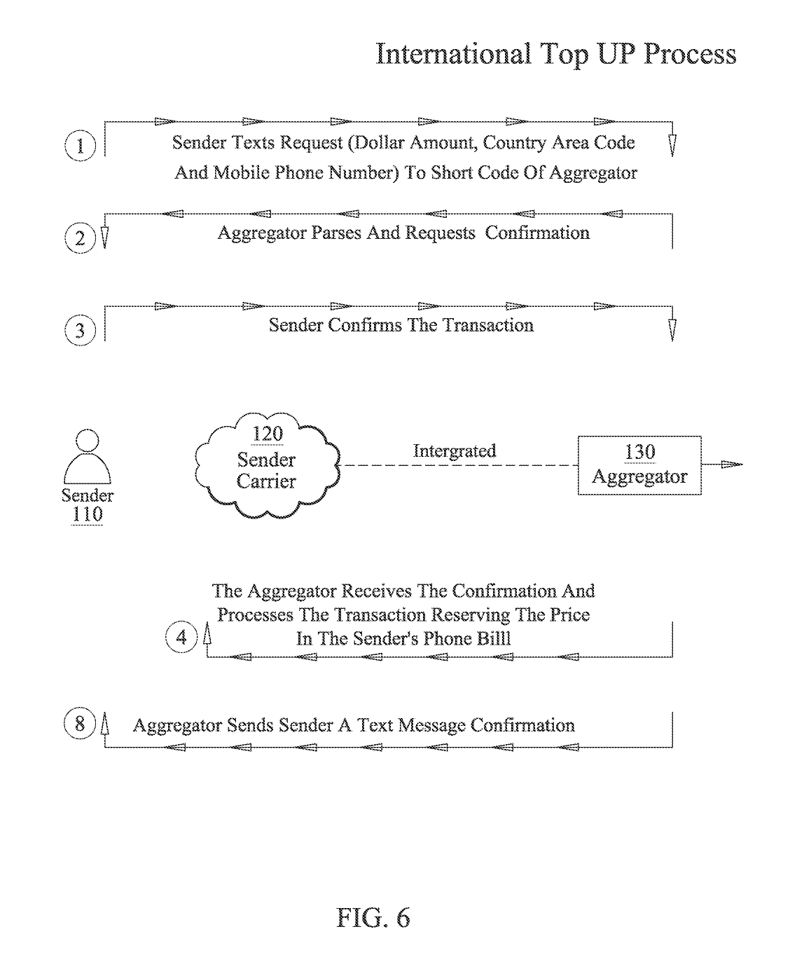

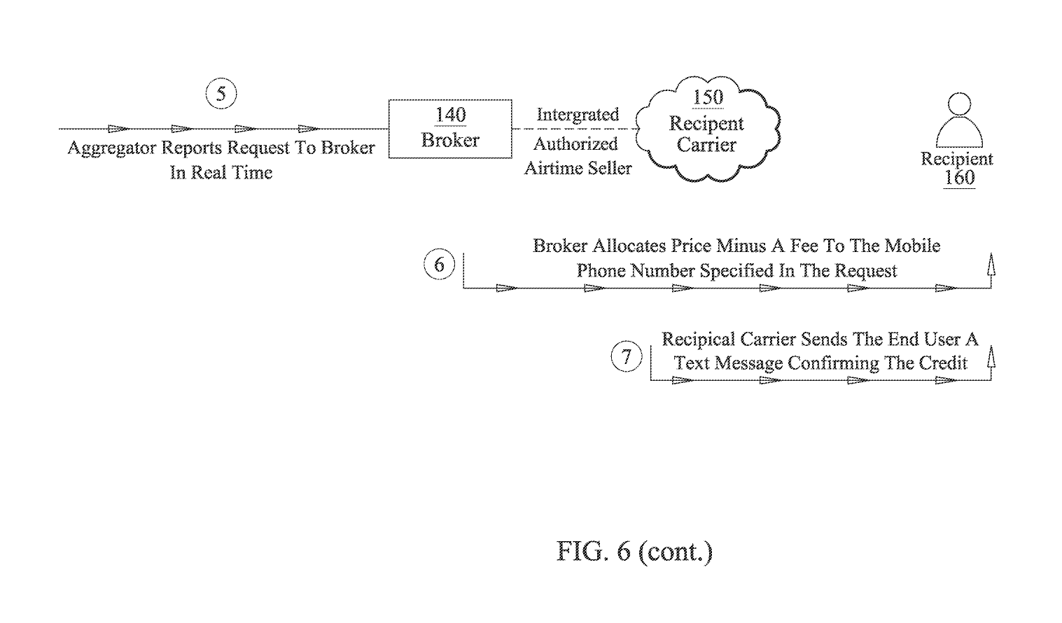

FIG. 6 shows the international top-up process. In step 1, a sender 110A begins the engagement by texting a purchase order including a dollar amount, country area code, and mobile phone number to a broker's mobile telephone number 11, which is managed by the aggregator 130. In step 2, a computer server of the aggregator 130 parses the purchase order and identifies the country area code and returns a text message 20 asking the sender to confirm the transaction by replying “yes” or “no”. In step 3, the sender confirms the transaction by sending a text message 30 containing “yes” to the broker's mobile telephone number 11. In step 4, the aggregator 130 receives the confirmation 30 and the broker 140 processes the transaction, reserving a monetary amount specified in the purchase order in the sender's telephone bill. In step 5, the aggregator 130 reports the purchase order to the broker in near real time 140. In step 6, the broker 140 credits value minus a fee charged by the broker 140 to the recipient's mobile phone number 15. In step 7, the recipient's carrier 150A sends the recipient 110E a text message confirming the purchase. In step 8, the sender 110A receives a text message 40 confirming completion of the transaction.

What is claimed is:

1. A method for financing a purchase for a recipient on an account of a sender, which comprises:
establishing the account of the sender with a creditor;
sending a purchase order from the sender to a broker of the creditor, the purchase order identifying the recipient and the good or service;
debiting the account of the sender for the good or service;
sending a purchase order for the good or service from the broker of creditor to a broker of a supplier, the purchase order identifying the recipient and the good or service;
sending a purchase order from the broker of the supplier to the supplier, the purchase order specifying the recipient and the good or service;
delivering the good or service from the supplier to the recipient; and
reimbursing the broker of the supplier after the sender credits the account.

2. The method according to claim 1, wherein:
said creditor is a mobile telephone service provider;
said sender is a mobile telephone user with a mobile telephone associated with said account established with said mobile telephone service provider; and
said purchase order from the sender to a broker of the creditor is sent from said mobile telephone of said sender.

3. The method according to claim 2, wherein said purchase order from the sender to a broker of the creditor is a text message sent by SMS protocol from said mobile telephone of the sender.

4. The method according to claim 3, wherein:
said good or service is mobile telephone airtime credit; and
said text message includes a telephone number of said recipient.

5. The method according to claim 4, wherein said text message includes a price to be charged to said account of said sender.

6. The method according to claim 5, wherein said amount is not greater than five United States dollars.

7. The method according to claim 3, wherein said text message is addressed to a number identifying said broker of the creditor.

8. The method according to claim 1, wherein the broker of supplier purchases the good or service before receiving the purchase order from the broker of the creditor.

9. The method according to claim 4, wherein said broker of said supplier instructs said supplier to deliver said mobile telephone airtime credit in near real time when the broker of the supplier receives the purchase order from the broker of the creditor.

10. A method for reimbursing a broker of a supplier, which comprises:
sending a purchase order from a broker of a creditor of a sender to the broker of the supplier, the purchase order specifying a price to the sender; and
sending a portion of the price to the broker of the supplier after the sender pays the price to the creditor.

11. A method for reimbursing a broker of mobile telephone airtime on another mobile telephone carrier, which comprises:
establishing an account for a mobile telephone user;
receiving an invoice for mobile telephone airtime on another carrier from the broker, the invoice identifying the account and a price to the mobile telephone user for the mobile telephone airtime; and
paying the broker when the mobile telephone user pays the account.

12. The method according to claim 11, which further comprises paying a portion of the price to the mobile telephone carrier.

13. A method for brokering a purchase of wireless telephone airtime for a recipient using a different carrier than a purchaser, which comprises:
receiving a purchase order from a mobile telephone user, the purchase order including a price to the purchaser;
sending an invoice to a carrier of the purchaser for the price; and
sending a purchase order for the wireless airtime to a broker of a carrier of the recipient.

14. The method according to claim 13, which further comprises reimbursing a portion of the price of the wireless airtime upon payment by the sender to the carrier of the sender.

15. The method according to claim 13, wherein the purchase order from the sender a text message sent by SMS protocol.

16. A method for selling mobile airtime of a first carrier to a purchaser using a second carrier, which comprises:
purchasing mobile telephone airtime on the first carrier;
allocating the mobile telephone airtime to a mobile telephone account of a recipient after receiving a purchase order; the purchase order identifying an account of the purchaser with the second carrier, identifying the mobile telephone account of the sender, and an amount of the mobile telephone airtime; and
sending an invoice to the second carrier, the invoice identifying the account of the purchaser and a price for the mobile telephone airtime.

17. The method according to claim 16, which further comprises purchasing the mobile air time from the first carrier before receiving the purchase order.

18. The method according to claim 17, which further comprises purchasing the mobile air time for a notional further recipient when purchasing the mobile telephone airtime from the first carrier.

22. A method for determining when to purchase a good or service from a supplier, which comprises purchasing the good or service from the supplier when the sale price to a sender minus the price for a sender broker to purchase the good or service is greater than a cost charged by a creditor of the sender and a cost charged by a broker of the creditor.

23. A method for determining a sum of cost to be charged by a creditor and cost to be charged by a broker of the creditor, which comprises:
subtracting a cost for a supplier broker to buy a good or service from a price to be charged by a sender to determine a margin; and
negotiating the sum of the cost to be charged by the creditor and the cost to be charged by the broker of the creditor to be less than the margin.
